(19) United States
(12) Patent Application Publication
(10) Pub. No.: US 2011/0148858 A1
(43) Pub. Date: Jun. 23, 2011

(54) VIEW SYNTHESIS WITH HEURISTIC VIEW MERGING

(76) Inventors: Zefeng Ni, Santa Barbara, CA (US); Dong Tian, Plainsboro, NJ (US); Sitaram Bhagavathy, Plainsboro, NJ (US); Joan Llach, Princeton, NJ (US)

(21) Appl. No.: 12/737,873

(22) PCT Filed: Aug. 28, 2009
(86) PCT No.: PCT/US2009/004905

§ 371 Date: Feb. 25, 2011

Related U.S. Application Data
(60) Provisional application No. 61/092,967, filed on Aug. 29, 2008.
(60) Provisional application No. 61/192,612, filed on Sep. 19, 2008.

(51) Int. Cl. H04N 13/00

(52) U.S. Cl. 345/419; 348/E13.001

(57) ABSTRACT

Several implementations relate to view synthesis with heuristic view merging for 3D Video (3DV) applications. According to one aspect, a first candidate pixel from a first warped reference view and a second candidate pixel from a second warped reference view are assessed based on at least one of a backward synthesis process to assess a quality of the first and second candidate pixels, a hole distribution around the first and second candidate pixels, or on an amount of energy around the first and second candidate pixels above a specified frequency. The assessing occurs as part of merging at least the first and second warped reference views into a signal synthesized view. Based on the assessing, a result is determined for a given target pixel in the single synthesized view. The result may be determining a value for the given target pixel, or marking the given target pixel as a hole.

### CROSS-REFERENCE TO RELATED APPLICATIONS

This application claims the benefit of both (1) U.S. Provisional Application Ser. No. 61/192,612, filed on Sep. 19, 2008, titled “View Synthesis with Boundary-Splatting and Heuristic View Merging for 3DV Applications”, and (2) U.S. Provisional Application Ser. No. 61/092,967, filed on Aug. 29, 2008, titled “View Synthesis with Adaptive Splatting for 3D Video (3DV) Applications”. The contents of both U.S. Provisional Applications are hereby incorporated by reference in their entirety for all purposes.

### TECHNICAL FIELD

Implementations are described that relate to coding systems. Various particular implementations relate to view synthesis with heuristic view merging for 3D Video (3DV) applications.

### BACKGROUND

Three dimensional video (3DV) is a new framework that includes a coded representation for multiple view video and depth information and targets, for example, the generation of high-quality 3D rendering at the receiver. This enables 3D visual experiences with auto-stereoscopic displays, free-view point applications, and stereoscopic displays. It is desirable to have further techniques for generating additional views.

### SUMMARY

According to a general aspect, a first candidate pixel from a first warped reference view and a second candidate pixel from a second warped reference view are assessed based on at least one of a backward synthesis process to assess a quality of the first and second candidate pixels, a hole distribution around the first and second candidate pixels, or on an amount of energy around the first and second candidate pixels above a specified frequency. The assessing occurs as part of merging at least the first and second warped reference views into a signal synthesized view. Based on the assessing, a result is determined for a given target pixel in the single synthesized view.

The details of one or more implementations are set forth in the accompanying drawings and the description below. Even if described in one particular manner, it should be clear that implementations may be configured or embodied in various manners. For example, an implementation may be performed as a method, or embodied as apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1A is a diagram of an implementation of non-rectified view synthesis.

FIG. 1B is a diagram of an implementation of rectified view synthesis.

FIG. 2A is a diagram of an implementation of a view synthesizer.

FIG. 2B is a diagram of an implementation of an image synthesizer.

FIG. 3 is a diagram of an implementation of a video transmission system.

FIG. 4 is a diagram of an implementation of a video receiving system.

FIG. 5 is a diagram of an implementation of a video processing device.

FIG. 6 is a diagram of an implementation of a system for transmitting and receiving multi-view video with depth information.

FIG. 7 is a diagram of an implementation of a view synthesis and merging process.

FIG. 8 is a diagram of an implementation of a merging process utilizing depth, hole distribution, and camera parameters.

FIG. 9 is a diagram of an implementation of a merging process utilizing depth, backward synthesis error, and camera parameters.

FIG. 10 is a diagram of another implementation of a merging process utilizing depth, backward synthesis error, and camera parameters.

FIG. 11 is a diagram of an implementation of a merging process utilizing high frequency energy.

### DETAILED DESCRIPTION

Some 3DV applications impose strict limitations on the input views. The input views must typically be well rectified, such that a one dimensional (1D) disparity can describe how a pixel is displaced from one view to another.

Depth-Image-Based Rendering (DIBR) is a technique of view synthesis which uses a number of images captured from multiple calibrated cameras and associated per-pixel depth information. Conceptually, this view generation method can be understood as a two-step process: (1) 3D image warping; and (2) reconstruction and re-sampling. With respect to 3D image warping, depth data and associated camera parameters are used to un-project pixels from reference images to the proper 3D locations and re-project them onto the new image space. With respect to reconstruction and re-sampling, the same involves the determination of pixel values in the synthesized view.

The rendering method can be pixel-based (splatting) or mesh-based (triangular). For 3DV, per-pixel depth is typically estimated with passive computer vision techniques such as stereo rather than generated from laser range scanning or computer graphics models. Therefore, for real-time processing in 3DV, given only noisy depth information, pixel-based methods should be favored to avoid complex and computational expensive mesh generation since robust 3D triangulation (surface reconstruction) is a difficult geometry problem.

Existing splatting algorithms have achieved some very impressive results. However, they are designed to work with high precision depth and might not be adequate for low quality depth. In addition, there are aspects that many existing algorithms take for granted, such as a per-pixel normal surface or a point-cloud in 3D, which do not exist in 3DV. As such, new synthesis algorithms are desired to address these specific issues.

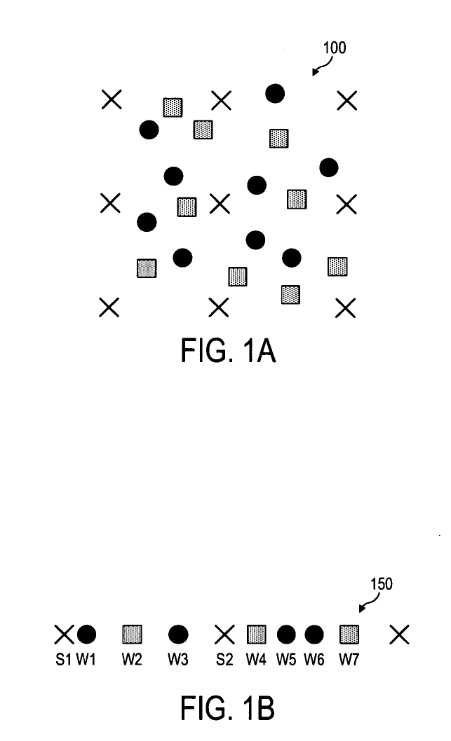

Given depth information and camera parameters, it is straightforward to warp reference pixels onto the synthesized view. The most significant problem is how to estimate pixel values in the target view from warped reference view pixels. FIGS. 1A and 1B illustrate this basic problem. FIG. 1A shows non-rectified view synthesis 100. FIG. 1B shows rectified view synthesis 150. In FIGS. 1A and 1B, the letter “X” represents a pixel in the target view that is to be estimated, and circles and squares represents pixels warped from different reference views, where the difference shapes indicates the difference reference views.

A simple method is to round the warped samples to its nearest pixel location in the destination view. When multiple pixels are mapped to the same location in the synthesized view, Z-buffering is a typical solution, i.e., the pixel closest to the camera is chosen. This strategy (rounding the nearest pixel location) can often result in pinholes in any surface that is slightly under-sampled, especially along object boundaries. The most common method to address this pinhole problem is to map one pixel in the reference view to several pixels in the target view. This process is called splatting.

If a reference pixel is mapped onto multiple surrounding target pixels in the target view, most of the pinholes can be eliminated. However, some image detail will be lost. The same trade-off between pinhole elimination and loss of detail occurs when using transparent splat-type reconstruction kernels. The question is: “how do we control the degree of splatting?” For example, for each warped pixel, shall we map it on all its surrounding target pixels or only map it to the one closest to it? This question is largely un-addressed in literatures.

When multiple reference views are employed, a common method will process the synthesis from each reference view separately and then merge multiple synthesized views together. The problem is how to merge them, for example, some sort of weighting scheme may be used. For example, different weights may be applied to different reference views based on the angular distance, image resolution, and so forth. Note that these problems should be addressed in a way that is robust to the noisy depth information.

Using DIBR, a virtual view can be generated from the captured views, also called as reference views in this context. It is a challenging task for the generation of a virtual view especially when the input depth information is noisy and no other scene information such as 3D surface property of the scene is known.

One of the most difficult problems is often how to estimate the value of each pixel in the synthesized view after the sample pixels in the reference views are warped. For example, for each target synthesized pixel, what reference pixels should be utilized, and how to combine them?

In at least one implementation, we propose a framework for view synthesis with boundary-splatting for 3DV applications. The inventors have noted that in 3DV applications (e.g., using DIBR) that involve the generation of a virtual view, such generation is a challenging task particularly when the input depth information is noisy and no other scene information such as a 3D surface property of the scene is known.

The inventors have further noted if a reference pixel is mapped onto multiple surrounding target pixels in the target view, while most of the pinholes can be eliminated, unfortunately some image detail will be lost. The same trade-off between pinhole elimination and loss of detail occurs when using transparent splat-type reconstruction kernels. The question is: “how do we control the degree of splatting?” For example, for each warped pixel, shall we map it on all its surrounding target pixels or only map it to the one closest to it?

In at least one implementation, we propose: (1) to apply splatting only to pixels around boundary layers, i.e., map pixels in regions that have little depth discontinuity only to their nearest neighboring pixel; and (2) two new heuristic merging schemes using hole-distribution or backward synthesis error with Z-buffer when merging synthesized images from multiple reference views.

Additionally, the inventors have noted that to synthesize a virtual view from reference views, three steps are generally needed, namely: (1) forward warping; (2) blending (single view synthesis and multi-view merging); and (3) hole-filling. At least one implementation contributes a few algorithms to improve blending to address the issues caused by noisy depth information. Our simulations have showed superior quality compared to some existing schemes in 3DV.

With respect to the warping step of the above mentioned three steps relating to synthesizing a virtual view from reference views, basically two options can be considered to exist with respect to how the warping results are processed, namely merging and blending.

With respect to merging, you can completely warp each view to form a final warped view for each reference. Then you can “merge” these final warped views to get a single really-final synthesized view. “Merging” would involve, e.g., picking between the N candidates (presuming there are N final warped views) or combining them in some way. Of course, it is to be appreciated that the number of candidates used to determine the target pixel value need not be the same as the number of warped views. That is, multiple candidates (or none at all) may come from a single view.

With respect to blending, you still warp each view, but you do not form a final warped view for each reference. By not going final, you preserve more options as you blend. This can be advantageous because in some cases different views may provide the best information for different portions of the synthesized target view. Hence, blending offers the flexibility to choose the right combination of information from different views at each pixel. Hence, merging can be considered as a special case of two-step blending wherein candidates from each view are first processed separately and then the results are combined.

Referring again to FIG. 1A, FIG. 1A can be taken to show the input to a typical blending operation because FIG. 1A includes pixels warped from different reference views (circles, and squares, respectively). In contrast, for a typical merging application, one would expect only to see either circles or squares, because each reference view would typically be warped separately and then processed to form a final warped view for the respective reference. The final warped views for the multiple references would then be combined in the typical merging application.

Returning back to blending, as one possible option/consideration relating to the same, you might not perform splatting because you do not want to fill all the holes yet. These and other options are readily determined by one of ordinary skill in this and related arts, while maintaining the spirit of the present principles.

Thus, it is to be appreciated that one or more embodiments of the present principles may be directed to merging, while other embodiments of the present principles may be directed to blending. Of course, further embodiments may involve a combination of merging and blending. Features and concepts discussed in this application may generally be applied to both blending and merging, even if discussed only in the context of only one of blending or merging. Given the teachings of the present principles provided herein, one of ordinary skill in this and related arts will readily contemplate various applications relating to merging and/or blending, while maintaining the spirit of the present principles.

It is to be appreciated that the present principles generally relate to communications systems and, more particularly, to wireless systems, e.g., terrestrial broadcast, cellular, Wireless-Fidelity (Wi-Fi), satellite, and so forth. It is to be further appreciated that the present principles may be implemented in, for example, an encoder, a decoder, a pre-processor, a post processor, and a receiver (which may include one or more of the preceding). For example, in an application where it is desirable to generate a virtual image to use for encoding purposes, then the present principles may be implemented in an encoder. As a further example with respect to an encoder, such an encoder could be used to synthesize a virtual view to use to encode actual pictures from that virtual view location, or to encode pictures from a view location that is close to the virtual view location. In implementations involving two reference pictures, both may be encoded, along with a virtual picture corresponding to the virtual view. Of course, given the teachings of the present principles provided herein, one of ordinary skill in this and related arts will contemplate these and various other applications, as well as variations to the preceding described application, to which the present principles may be applied, while maintaining the spirit of the present principles.

Additionally, it is to be appreciated that while one or more embodiments are described herein with respect to the H.264/MPEG-4 AVC (AVC) Standard, the present principles are not limited solely to the same and, thus, given the teachings of the present principles provided herein, may be readily applied to multi-view video coding (MVC), current and future 3DV Standards, as well as other video coding standards, specifications, and/or recommendations, while maintaining the spirit of the present principles.

Note that “splatting” refers to the process of mapping one warped pixel from a reference view to several pixels in the target view.

Note that “depth information” is a general term referring to various kinds of information about depth. One type of depth information is a “depth map”, which generally refers to a per-pixel depth image. Other types of depth information include, for example, using a single depth value for each coded block rather than for each coded pixel.

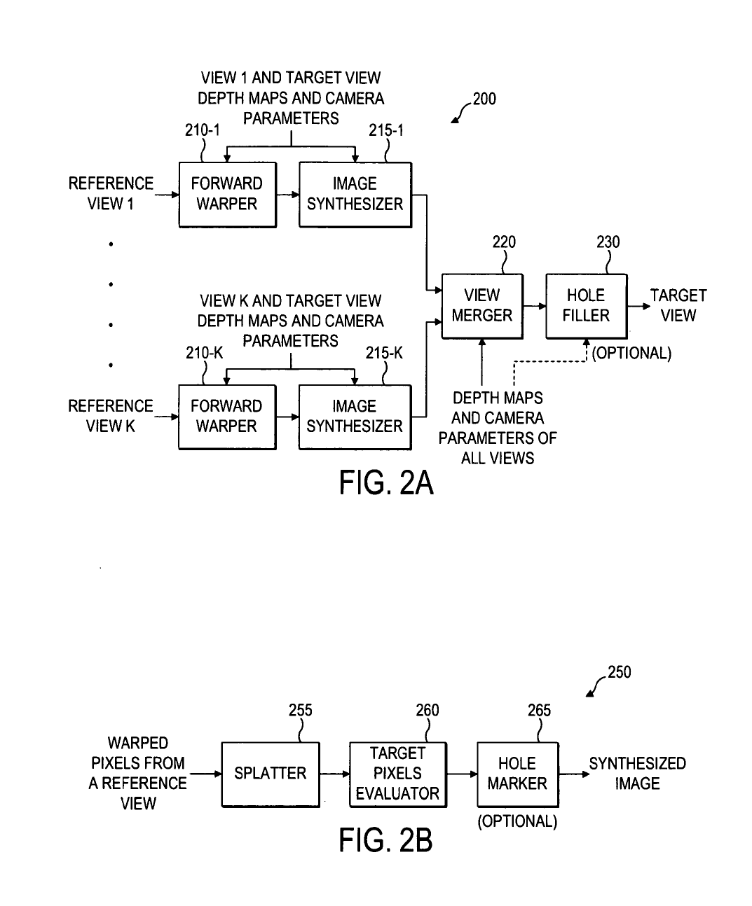

FIG. 2A shows an exemplary view synthesizer 200 to which the present principles may be applied, in accordance with an embodiment of the present principles. The view synthesizer 200 includes forward warpers 210-1 through 210-K, a view merger 220, and a hole filler 230. Respective outputs of forward warpers 210-1 through 210-K are connected in signal communication with respective inputs of image synthesizers 215-1 through 215-K. Respective outputs of image synthesizers 215-1 through 215-K are connected in signal communication with a first input of the view merger 220. An output of the view merger 220 is connected in signal communication with a first input of hole filler 230. First respective inputs of forward warpers 210-1 through 210-K are available as inputs of the view synthesizer 200, for receiving respective reference views 1 through K. Second respective inputs of forward warpers 210-1 through 210-K and second respective inputs of the image synthesizers 215-1 through 215-K are available as inputs of the view synthesizer 200, for respectively receiving view 1 and target view depths maps and camera parameters corresponding thereto, up through view K and target view depth maps and camera parameters corresponding thereto. A second input of the view merger 220 is available as an input of the view synthesizer, for receiving depth maps and camera parameters of all views. A second (optional) input of the hole filler 230 is available as an input of the view synthesizer 200, for receiving depth maps and camera parameters of all views. An output of the hole filler 230 is available as an output of the view synthesizer 200, for outputting a target view.

FIG. 2B shows an exemplary image synthesizer 250 to which the present principles may be applied, in accordance with an embodiment of the present principles. The image synthesizer 250 includes a splatter 255 having an output connected in signal communication with an input of a target pixels evaluator 260. An output of the target pixels evaluator 260 is connected in signal communication with an input of a hole marker 265. An input of the splatter 255 is available as an input of the image synthesizer 250, for receiving warped pixels from a reference view. An output of the hole marker 265 is available as an output of the image synthesizer 250, for outputting a synthesized image. It is to be appreciated that the hole marker 265 is optional, and may be omitted in some implementation where hole marking is not needed, but target pixel evaluation is sufficient.

Splatter 255 may be implemented in various ways. For example, a software algorithm performing the functions of splatting may be implemented on a general-purpose computer or a dedicated-purpose machine such as, for example, a video encoder. The general functions of splatting are well known to one of ordinary skill in the art. Such an implementation may be modified as described in this application to perform, for example, the splatting functions based on whether a pixel in a warped reference is within a specified distance from one or more depth boundaries. Splatting functions, as modified by the implementations described in this application, may alternatively be implemented in a special-purpose integrated circuit (such as an application-specific integrated circuit (ASIC)) or other hardware. Implementations may also use a combination of software, hardware, and firmware.

Other elements of FIGS. 2A and 2B, such as, for example, forward warpers 210, hole marker 265, and target pixels evaluator 260, may be implemented as with splatter 255. For example, implementations of a forward warper 210 may use software, hardware, and/or firmware to perform the well-known functions of warping on a general-purpose computer or application-specific device or application-specific integrated circuit. Additionally, implementations of a hole marker 265 may use, for example, software, hardware, and/or firmware to perform the functions described in various embodiments for marking a hole, and these functions may be performed on, for example, a general-purpose computer or application-specific device or application-specific integrated circuit. Further, implementations of a target pixel evaluator 260 may use, for example, software, hardware, and/or firmware to perform the functions described in various embodiments for evaluating a target pixel, and these functions may be performed on, for example, a general-purpose computer or application-specific device or application-specific integrated circuit.

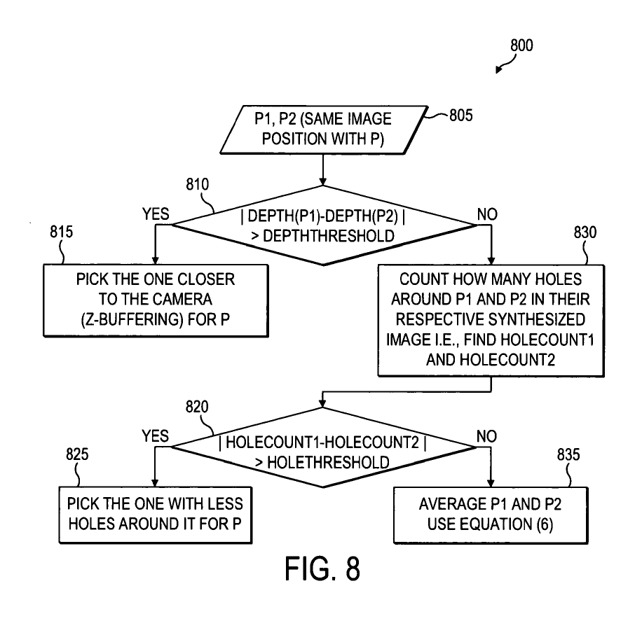

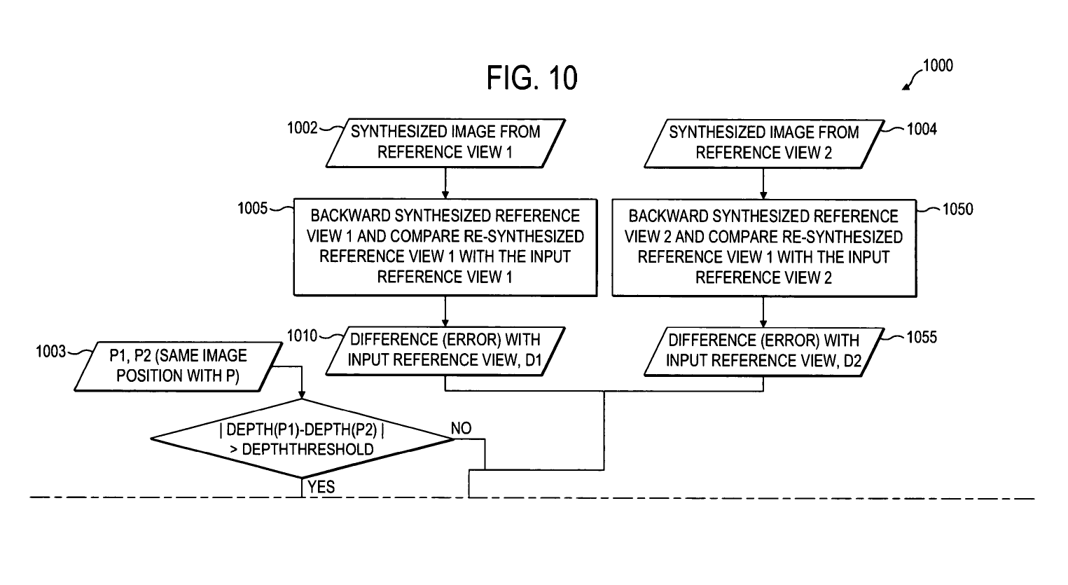

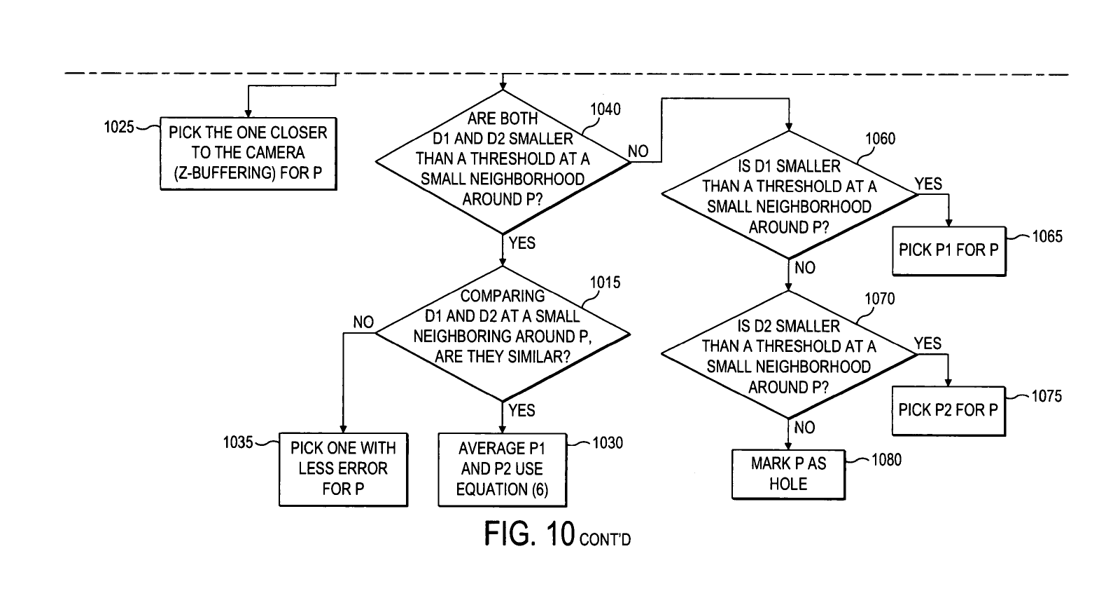

Further, view merger 220 may also include a hole marker such as, for example, hole marker 265 or a variation of hole marker 265. In such implementations, view merger 220 will also be capable of marking holes, as described for example in the discussion of Embodiments 2 and 3 and FIGS. 8 and 10.

Additionally, view merger 220 may be implemented in various ways. For example, a software algorithm performing the functions of view merging may be implemented on a general-purpose computer or a dedicated-purpose machine such as, for example, a video encoder. The general functions of view merging are well known to one of ordinary skill in the art. Such an implementation, however, may be modified as described in this application to perform, for example, the view merging techniques discussed for one or more implementations of this application. View merging functions, as modified by the implementations described in this application, may alternatively be implemented in a special-purpose integrated circuit (such as an application-specific integrated circuit (ASIC)) or other hardware. Implementations may also use a combination of software, hardware, and firmware.

Some implementations of view merger 220 include functionality for assessing a first candidate pixel from a first warped reference view and a second candidate pixel from a second warped reference view based on at least one of a backward synthesis process to assess a quality of the first and second candidate pixels, a hole distribution around the first and second candidate pixels, or on an amount of energy around the first and second candidate pixels above a specified frequency. Some implementations of view merger 220 further include functionality for determining, based on the assessing, a result for a given target pixel in the single synthesized view. Both of these functionalities are described, for example, in the discussion of FIG. 10 and other parts of this application. Such implementations may include, for example, a single set of instructions, or different (including overlapping) sets of instructions, for performing each of these functions, and such instructions may be implemented on, for example, a general-purpose computer, a special-purpose machine (such as, for example, a video encoder), or an application-specific integrated circuit. Further, such functionality may be implemented using various combinations of software, hardware, or firmware.

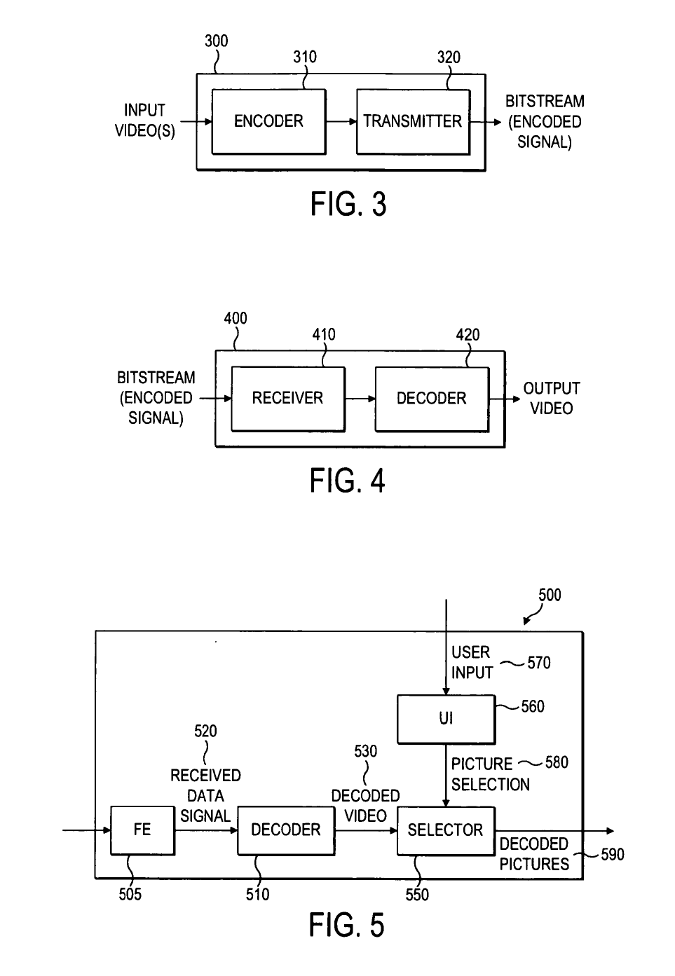

FIG. 3 shows an exemplary video transmission system 300 to which the present principles may be applied, in accordance with an implementation of the present principles. The video transmission system 300 may be, for example, a head-end or transmission system for transmitting a signal using any of a variety of media, such as, for example, satellite; cable, telephone-line, or terrestrial broadcast. The transmission may be provided over the Internet or some other network.

The video transmission system 300 is capable of generating and delivering video content encoded using inter-view skip mode with depth. This is achieved by generating an encoded signals) including depth information or information capable of being used to synthesize the depth information at a receiver end that may, for example, have a decoder.

The video transmission system 300 includes an encoder 310 and a transmitter 320 capable of transmitting the encoded signal. The encoder 310 receives video information and generates an encoded signal(s) there from using inter-view skip mode with depth. The encoder 310 may be, for example, an AVC encoder. The encoder 310 may include sub-modules, including for example an assembly unit for receiving and assembling various pieces of information into a structured format for storage or transmission. The various pieces of information may include, for example, coded or uncoded video, coded or uncoded depth information, and coded or uncoded elements such as, for example, motion vectors, coding mode indicators, and syntax elements.

The transmitter 320 may be, for example, adapted to transmit a program signal having one or more bitstreams representing encoded pictures and/or information related thereto. Typical transmitters perform functions such as, for example, one or more of providing error-correction coding, interleaving the data in the signal, randomizing the energy in the signal, and modulating the signal onto one or more carriers. The transmitter may include, or interface with, an antenna (not shown). Accordingly, implementations of the transmitter 320 may include, or be limited to, a modulator.

FIG. 4 shows an exemplary video receiving system 400 to which the present principles may be applied, in accordance with an embodiment of the present principles. The video receiving system 400 may be configured to receive signals over a variety of media, such as, for example, satellite, cable, telephone-line, or terrestrial broadcast. The signals may be received over the Internet or some other network.

The video receiving system 400 may be, for example, a cell-phone, a computer, a set-top box, a television, or other device that receives encoded video and provides, for example, decoded video for display to a user or for storage. Thus, the video receiving system 400 may provide its output to, for example, a screen of a television, a computer monitor, a computer (for storage, processing, or display), or some other storage, processing, or display device.

The video receiving system 400 is capable of receiving and processing video content including video information. The video receiving system 400 includes a receiver 410 capable of receiving an encoded signal, such as for example the signals described in the implementations of this application, and a decoder 420 capable of decoding the received signal.

The receiver 410 may be, for example, adapted to receive a program signal having a plurality of bitstreams representing encoded pictures. Typical receivers perform functions such as, for example, one or more of receiving a modulated and encoded data signal, demodulating the data signal from one or more carriers, de-randomizing the energy in the signal, de-interleaving the data in the signal, and error-correction decoding the signal. The receiver 410 may include, or interface with, an antenna (not shown). Implementations of the receiver 410 may include, or be limited to, a demodulator.

The decoder 420 outputs video signals including video information and depth information. The decoder 420 may be, for example, an AVC decoder.

FIG. 5 shows an exemplary video processing device 500 to which the present principles may be applied, in accordance with an embodiment of the present principles. The video processing device 500 may be, for example, a set top box or other device that receives encoded video and provides, for example, decoded video for display to a user or for storage. Thus, the video processing device 500 may provide its output to a television, computer monitor, or a computer or other processing device.

The video processing device 500 includes a front-end (FE) device 505 and a decoder 510. The front-end device 505 may be, for example, a receiver adapted to receive a program signal having a plurality of bitstreams representing encoded pictures, and to select one or more bitstreams for decoding from the plurality of bitstreams. Typical receivers perform functions such as, for example, one or more of receiving a modulated and encoded data signal, demodulating the data signal, decoding one or more encodings (for example, channel coding and/or source coding) of the data signal, and/or error-correcting the data signal. The front-end device 505 may receive the program signal from, for example, an antenna (not shown). The front-end device 505 provides a received data signal to the decoder 510.

The decoder 510 receives a data signal 520. The data signal 520 may include, for example, one or more Advanced Video Coding (AVC), Scalable Video Coding (SVC), or Multi-view Video Coding (MVC) compatible streams.

AVC refers more specifically to the existing International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “H.264/MPEG-4 AVC Standard” or variations thereof, such as the “AVC standard” or simply “AVC”).

MVC refers more specifically to a multi-view video coding (“MVC”) extension (Annex H) of the AVC standard, referred to as H.264/MPEG-4 AVC, MVC extension (the “MVC extension” or simply “MVC”).

SVC refers more specifically to a scalable video coding (“SVC”) extension (Annex G) of the AVC standard, referred to as H.264/MPEG-4 AVC, SVC extension (the “SVC extension” or simply “SVC”).

The decoder 510 decodes all or part of the received signal 520 and provides as output a decoded video signal 530. The decoded video 530 is provided to a selector 550. The device 500 also includes a user interface 560 that receives a user input 570. The user interface 560 provides a picture selection signal 580, based on the user input 570, to the selector 550. The picture selection signal 580 and the user input 570 indicate which of multiple pictures, sequences, scalable versions, views, or other selections of the available decoded data a user desires to have displayed. The selector 550 provides the selected picture(s) as an output 590. The selector 550 uses the picture selection information 580 to select which of the pictures in the decoded video 530 to provide as the output 590.

In various implementations, the selector 550 includes the user interface 560, and in other implementations no user interface 560 is needed because the selector 550 receives the user input 570 directly without a separate interface function being performed. The selector 550 may be implemented in software or as an integrated circuit, for example. In one implementation, the selector 550 is incorporated with the decoder 510, and in another implementation, the decoder 510, the selector 550, and the user interface 560 are all integrated.

In one application, front-end 505 receives a broadcast of various television shows and selects one for processing. The selection of one show is based on user input of a desired channel to watch. Although the user input to front-end device 505 is not shown in FIG. 5, front-end device 505 receives the user input 570. The front-end 505 receives the broadcast and processes the desired show by demodulating the relevant part of the broadcast spectrum, and decoding any outer encoding of the demodulated show. The front-end 505 provides the decoded show to the decoder 510. The decoder 510 is an integrated unit that includes devices 560 and 550. The decoder 510 thus receives the user input, which is a user-supplied indication of a desired view to watch in the show. The decoder 510 decodes the selected view, as well as any required reference pictures from other views, and provides the decoded view 590 for display on a television (not shown).

Continuing the above application, the user may desire to switch the view that is displayed and may then provide a new input to the decoder 510. After receiving a “view change” from the user, the decoder 510 decodes both the old view and the new view, as well as any views that are in between the old view and the new view. That is, the decoder 510 decodes any views that are taken from cameras that are physically located in between the camera taking the old view and the camera taking the new view. The front-end device 505 also receives the information identifying the old view, the new view, and the views in between. Such information may be provided, for example, by a controller (not shown in FIG. 5) having information about the locations of the views, or the decoder 510. Other implementations may use a front-end device that has a controller integrated with the front-end device.

The decoder 510 provides all of these decoded views as output 590. A post-processor (not shown in FIG. 5) interpolates between the views to provide a smooth transition from the old view to the new view, and displays this transition to the user. After transitioning to the new view, the post-processor informs (through one or more communication links not shown) the decoder 510 and the front-end device 505 that only the new view is desired. Thereafter, the decoder 510 only provides as output 590 the new view.

The system 500 may be used to receive multiple views of a sequence of images, and to present a single view for display, and to switch between the various views in a smooth manner. The smooth manner may involve interpolating between views to move to another view. Additionally, the system 500 may allow a user to rotate an object or scene, or otherwise to see a three-dimensional representation of an object or a scene. The rotation of the object, for example, may correspond to moving from view to view, and interpolating between the views to obtain a smooth transition between the views or simply to obtain a three-dimensional representation. That is, the user may “select” an interpolated view as the “view” that is to be displayed.

The elements of FIGS. 2A and 2B may be incorporated at various locations in FIGS. 3-5. For example, one or more of the elements of FIGS. 2A and 2B may be located in encoder 310 and decoder 420. As a further example, implementations of video processing device 500 may include one or more of the elements of FIGS. 2A and 2B in decoder 510 or in the post-processor referred to in the discussion of FIG. 5 which interpolates between received views.

Returning to a description of the present principles and environments in which they may be applied, it is to be appreciated that advantageously, the present principles may be applied to 3D Video (3DV). 3D Video is a new framework that includes a coded representation for multiple view video and depth information and targets the generation of high-quality 3D rendering at the receiver. This enables 3D visual experiences with auto-multiscopic displays.

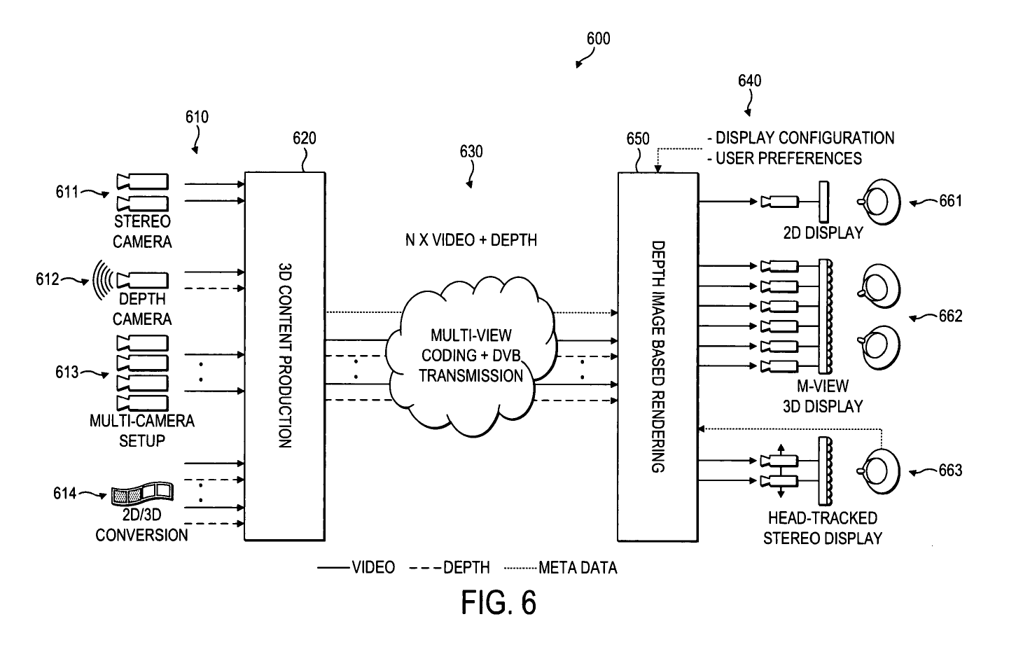

FIG. 6 shows an exemplary system 600 for transmitting and receiving multi-view video with depth information, to which the present principles may be applied, according to an embodiment of the present principles. In FIG. 6, video data is indicated by a solid line, depth data is indicated by a dashed line, and meta data is indicated by a dotted line. The system 600 may be, for example, but is not limited to, a free-viewpoint television system. At a transmitter side 610, the system 600 includes a three-dimensional (3D) content producer 620, having a plurality of inputs for receiving one or more of video, depth, and meta data from a respective plurality of sources. Such sources may include, but are not limited to, a stereo camera 611, a depth camera 612, a multi-camera setup 613, and 2-dimensional/3-dimensional (2D/3D) conversion processes 614. One or more networks 630 may be used for transmit one or more of video, depth, and meta data relating to multi-view video coding (MVC) and digital video broadcasting (DVB).

At a receiver side 640, a depth image-based renderer 650 performs depth image-based rendering to project the signal to various types of displays. This application scenario may impose specific constraints such as narrow angle acquisition (<20 degrees). The depth image-based renderer 650 is capable of receiving display configuration information and user preferences. An output of the depth image-based renderer 650 may be provided to one or more of a 2D display 661, an M-view 3D display 662, and/or a head-tracked stereo display 663.

### Forward Warping

The first step in performing view synthesis is forward warping, which involves finding, for each pixel in the reference view(s), its corresponding position in the target view. This 3D image warping is well known in computer graphics. Depending on whether input views are rectified, different equations can be used.

### (a) Non-Rectified View

If we define a 3D point by its homogeneous coordinates P=[x, y, z, l]^{T}, and its perspective projection in the reference image plane (i.e. 2D image location) is pᵣ=[uᵣ, vᵣ, l]^{T}, then we have the following:

wᵣ·pᵣ=PPMᵣ·P, (1)

where wᵣ is the depth factor, and PPMᵣ is the 3×4 perspective projection matrix, known from the camera parameters. Correspondingly, we get the equation for the synthesized (target) view as follows:

wₛ·pₛ=PPMₛ·P. (2)

We denote the twelve elements of PPMᵣ as qᵢⱼ with i=1, 2, 3, and j=1, 2, 3, 4. From image point pᵣ and its depth z, the other two components of the 3D point P can be estimated by a linear equation as follows:

$$[ \begin{matrix}{a}_{11} & {a}_{12} \\ {a}_{21} & {a}_{22}\end{matrix} ] [ \begin{matrix}x \\ y\end{matrix} ] = [ \begin{matrix}{b}_{1} \\ {b}_{2}\end{matrix} ] , \qquad ( 3 )$$

with

b₁=(q₁₄−q₃₄)+(q₁₃−q₃₃)z, a₁₁=uᵣq₃₁−q₁₁, a₁₂=uᵣq₃₂−q₁₂.

b₂=(q₂₄−q₃₄)+(q₂₃−q₃₃)z, a₂₁=vᵣq₃₁−q₂₁, a₂₂=vᵣq₃₂−q₂₂.

Note that the input depth level of each pixel in the reference views is quantized to eight bits (i.e., 256 levels, where larger values mean closer to the camera) in 3DV. The depth factor z used during the warping is directly linked to its input depth level Y with the following formula:

$$z = \frac{1}{\frac{Y}{255} ( \frac{1}{{Z}_{near}} - \frac{1}{{Z}_{far}} ) + \frac{1}{{Z}_{far}}} , \qquad ( 4 )$$

where Zₙₑₐᵣ and Z_{far} correspond to the depth factor of the nearest pixel and the furthest pixel in the scene, respectively. When more (or less) than 8 bits are used to quantize depth information, the value 255 in equation (4) should be replaced by 2^{B}-1, where B is the bit depth.

When the 3D position of P is known, and we re-project it onto the synthesized image plane by Equation (2), we get its position in the target view pₛ (i.e. warped pixel position).

### (b) Rectified View

For rectified views, a 1-D disparity (typically along a horizontal line) describes how a pixel is displaced from one view to another. Assume the following camera parameters are given:
(i) f, focal length of the camera lens;
(ii) l, baseline spacing, also known as camera distance; and
(iii) du, difference in principal point offset.

Considering that the input views are well rectified, the following formula can be used to calculate the warped position pₛ=[uₛ, vₛ, l]^{T} in the target view from the pixel pᵣ=[uᵣ, vᵣ, l]^{T} in the reference view:

$${u}_{s} = {u}_{r} - \frac{f \cdot l}{z} + du ; {v}_{s} = {v}_{r} . \qquad ( 5 )$$

### Sub-Pixel Precision at Reference Views and Synthesized View

To improve image quality at the synthesized view, reference views can be up-sampled, that is, new sub-pixels are inserted at half-pixel positions and maybe quarter-pixel positions or even finer resolutions. The depth image can be up-sampled accordingly. The sub-pixels in the reference views are warped in the same way as integer reference pixels (i.e., the pixels warped to full-pixel positions). Similarly, in the synthesized view, new target pixels can be inserted at sub-pixel positions.

It is to be appreciated that while one or more implementations are described with respect to half-pixels and half-pixel positions, the present principles are also readily applicable to any size sub-pixels (and, hence, corresponding sub-pixel positions), while maintaining the spirit of the present principles.

### Proposed Method: View Blending

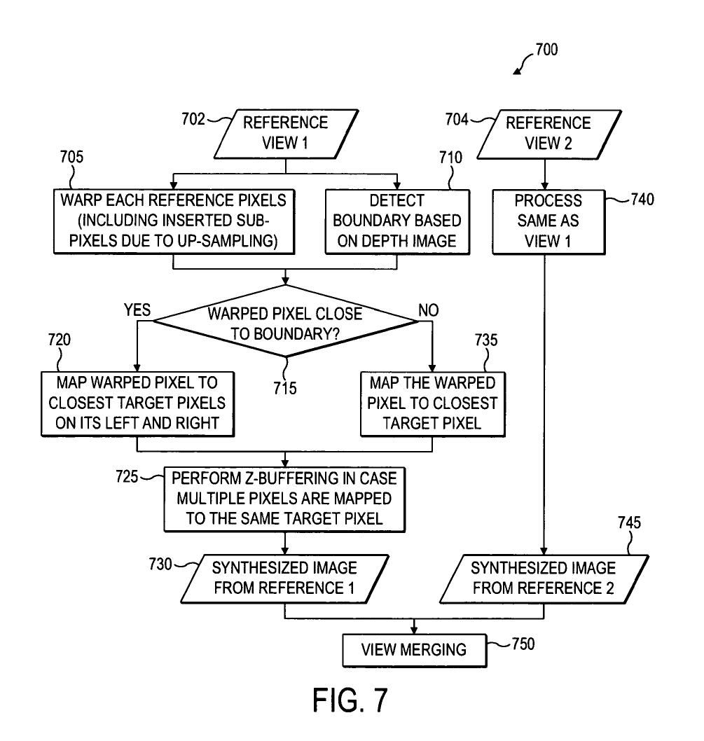

The result of the view warping is illustrated in FIGS. 1A and 1B. Here, we shall address the problem of how to estimate the pixel value in the target view from its surrounding warped reference pixels. FIG. 7 shows a view synthesis and merging process 700, in accordance with an embodiment of the present principles. The process 700 is performed after warping, and includes boundary-layer splatting for single-view synthesis and a new view merging scheme. At step 702, a reference view 1 is input to the process 700. At step 704, a reference view 2 is input to the process 700. At step 705, each reference pixel (including inserted sub-pixels due to up-sampling) is warped. At step 710, a boundary is detected based on a depth image. At step 715, it is determined whether or not the warped pixel is close to the boundary. If so, then control is passed to a step 720. Otherwise, control is passed to a step 735.

At step 720, the warped pixel is mapped to the closest target pixels on its left and right.

At step 725, Z-buffering is performed in case multiple pixels are mapped to the same target pixel.

At step 730, an image synthesized from reference 1 is input/obtained from the previous processing. At step 740, processing is performed on reference view 2 similar to that performed with respect to reference view 1. At step 745, an image synthesized from reference 2 is input/obtained from the previous processing.

At step 750, view merging is performed to merge the image synthesized from reference 1 and the image synthesized from reference 2.

### Embodiment 1: Boundary-Layer Splatting

As explained above, to reduce pinholes, a warped pixel is mapped to multiple neighboring target pixels. In the case of a rectified view, it is typically mapped to the target pixels on its left and right. For simplicity, we shall explain the proposed method for the case of rectified views (FIG. 1B). For example, in FIG. 1B, warped pixel W1 is mapped to target pixels S1 and S2. However, we find this could affect the image quality (i.e., high frequency details are lost due to splatting) especially when sub-pixel precision is used. Noticing that pin-holes mostly occur around the boundary between the foreground and background, i.e., a boundary with a large depth discontinuity, we propose to apply splatting only for pixels close to the boundary. In the case of FIG. 1B, if pixel W1 is not close to boundary (e.g., further than a 50 pixel distance from the boundary), it is mapped only to its closest target pixel S1. Of course, the preceding 50 pixel distance is merely illustrative and, thus, other pixel distances may also be used, as readily contemplated by one of ordinary skill in this and related arts, while maintaining the spirit of the present principles.

The “boundary” here only refers to the part(s) of the image with a large depth discontinuity and, hence, is easy to detect from the depth image of the reference view. For those pixels that are regarded as boundaries, splatting is performed in forward warping. On the other hand, splatting is disabled for pixels that are far away from boundaries, which helps to preserve high frequency details inside of objects without much depth variation especially when sub-pixel precision is used at the synthesized image. In another embodiment, the depth image of the reference views is forward warped to the virtual position and then followed by the boundary layer extraction in the synthesized depth image. Once a pixel is warped to the boundary area, splatting is performed.

When multiple warped pixels are mapped to the same target pixel in the synthesized view, an easy Z-buffering scheme (picking the pixel closer to the camera) can be applied by comparing depth levels. Of course, any other weighting scheme to average them can also be used, while maintaining the spirit of the present principles.

### Embodiment 2

### Merging Based on Z-Buffering, Hole Distribution, and Camera Positions

When more than one reference view is available, a merging process is generally needed when a synthesized image is generated separately from each view as illustrated in FIG. 7 for the case of two views. The question is how to combine them, i.e., how to get the value of a target pixel p in the merged image from p1 (collocated pixel on the synthesized image from reference view 1) and p2 (collocated pixel on the synthesized image from reference view 2)?

Some pixels in the synthesized image are never assigned a value during the blending step. These locations are called holes, often caused by dis-occlusions (previous invisible scene points in the reference views that are uncovered in the synthesized view due to differences in viewpoint) or due to input depth error.

When either p1 or p2 is a hole, the pixel value of the non-hole pixel will be assigned top in the final merged image. A conflict occurs when neither of p1 and p2 are holes. If both p1 and p2 are holes, a hole filling method is used, and various such methods are known in the art. The simplest scheme is again to apply Z-buffering, i.e., choose the pixel closer to the camera by comparing their depth levels. However, since the input depth images are noisy and p1 and p2 are from two different reference views whose depth images might not be consistent, simply applying Z-buffering may result in many artifacts on the final merged image. In this case, averaging p1 and p2 as follows may reduce artifacts:

p=(p1*w1+p2*w2)/(w1+w2), (6)

where w1 and w2 are the view weighting factors. In one implementation, they can simply be set to one (1). For rectified views, we recommend setting them based on baseline spacing lᵢ (the camera distance between view i and the synthesized view), e.g., wi=1/lᵢ. Again any other existing weighting scheme can be applied, combining one or several parameters.

FIG. 8 shows a merging process utilizing depth, hole distribution, and camera parameters, in accordance with an embodiment of the present principles. At step 805, p1, p2 (same image position with p) are input to process 800. At step 810, it is determined whether or not|depth(p1)−depth(p2)|>depthThreshold. If so, then control is passed to a step 815. Otherwise, control is passed to a step 830.

At step 815, the one (either p1 or p2) closer to the camera (i.e., Z-buffering) is picked for p.

At step 830, a count is performed of how many holes are around p1 and p2 in their respective synthesized image (i.e., find holeCount1 and holeCount2).

At step 820, it is determined whether or not |holeCount1−holeCount2|>holeThreshold. If so, then control is passed to a step 825. Otherwise, control is passed to a step 835.

At step 825, the one (either p1 or p2) with less holes around it is picked for p.

At step 835, p1 and p2 are averages using Equation (6).

With respect to process 800, the basic idea is to apply Z-buffering whenever the depths differ a lot (e.g., |depth(p1)−depth(p2)|>depthThreshold). It is to be appreciated that the preceding depth amount used is merely illustrative and, thus, other amounts may also be used, while maintaining the spirit of the present principles. When the depth levels are similar, then we check the hole distribution around p1 and p2. In one example, the number of hole pixels surrounding p1 and p2 are counted, i.e., find holeCount1 and holeCount2. If they differ a lot (e.g. |holeCount1−holeCount2|>holeThreshold), pick the one with less holes around it. It is to be appreciated that the preceding hole count amount used is merely illustrative and, thus, other amounts may also be used, while maintaining the spirit of the present principles. Otherwise, apply equation (6) for averaging. Note that different neighborhoods can be used to count the number of holes, for instance based on image size or computational constrains. Further note also that hole counts can also be used to compute view weighting factors.

In addition to the simple hole counting, hole locations can also be taken into account. For example, a pixel with the holes scattered around is less preferred compared to a pixel with most holes located on one side (either on its left side or its right side in horizontal camera arrangements).

In a different implementation, both p1 and p2 would be discarded if none of them are considered good enough. As a result, p will be marked as a hole and its value is derived based on a hole filling algorithm. For instance, p1 and p2 are discarded if their respective hole counts are both above a threshold holeThreshold2.

It is to be appreciated that “surrounding holes” may comprise only adjacent pixels to a particular target pixel in one implementation, or may comprise the pixels within a pre-determined number of pixels distance from the particular target pixel. These and other variations are readily contemplated by one of ordinary skill in this and related arts, while maintaining the spirit of the present principles.

### Embodiment 3: Using Backward Synthesis Error

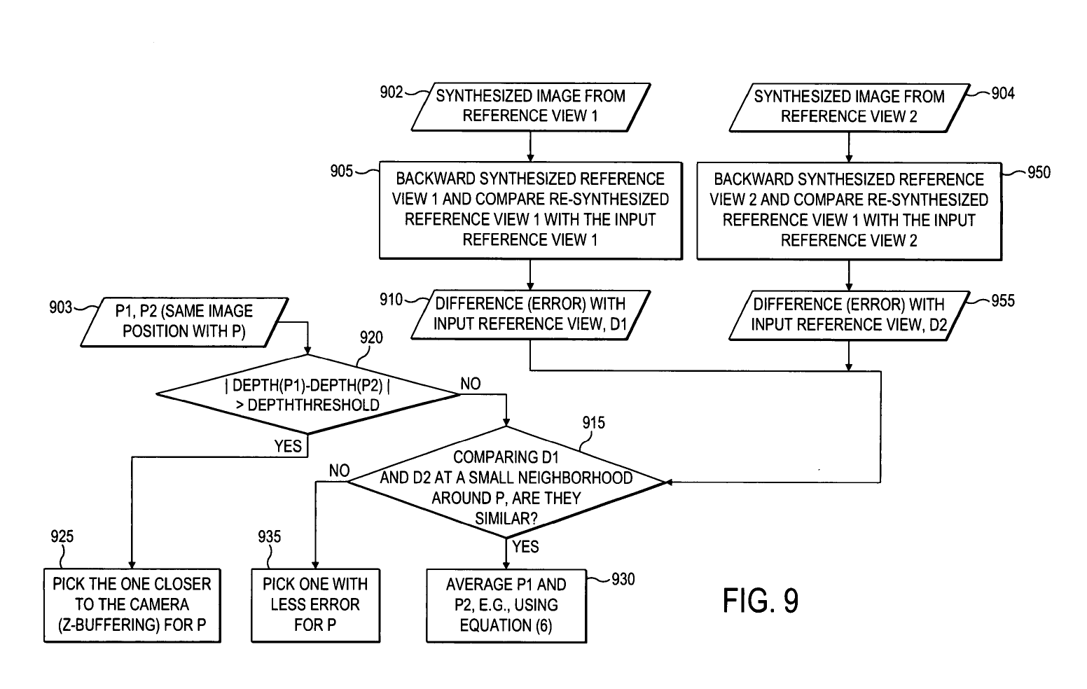

In Embodiment 2, the surrounding hole-distribution is used together with Z-buffering for the merging process to deal with noisy depth images. Here, we propose another way to help the view merging as shown in FIG. 9. FIG. 9 shows a merging process utilizing depth, backward synthesis error, and camera parameters, in accordance with an embodiment of the present principles. At step 902, a synthesized image from reference view 1 is input to the process 900. At step 904, a synthesized image from reference view 2 is input to the process 900. At step 903, p1, p2 (same image position with p) is input to the process. At step 905, reference view 1 is backward synthesized, and the re-synthesized reference view 1 is compared with input reference view 1. At step 910, the difference (error) with the input reference view, D1, is input to the process 900. At step 915, D1 and D2 are compared at a small neighborhood around p, and it is determined whether or not they are similar. If so, the control is passed to a function block 930. Otherwise, control is passed to a function block 935.

At step 930, p1 and p2 are averages using Equation (6).

At step 935, the one (either p1 or p2) with less error is picked for p.

At step 920, it is determined whether or not |depth(p1)−depth(p2)|>depthThreshold. If so, then control is passed to a step 925. Otherwise, control is passed to step 915.

At step 925, the one (either p1 or p2) closer to the camera (i.e., Z-buffering) is picked for p.

At step 950, reference view 2 is backward synthesized, and the re-synthesized reference view 2 is compared with input reference view 2. At step 955, the difference (error) with the input reference view, D2, is input to the process 900.

From each synthesized image (together with synthesized depth), we re-synthesize the original reference view and find the error between the backward synthesized image and the input reference image. Let us call it backward synthesis error image D. Applying this process to reference images 1 and 2, we get D1 and D2. During the merging step, when p1 and p2 are of similar depth, if the backward synthesis error D1 in a neighborhood around p1 (e.g. sum of errors within the 5×5 pixel range) is much larger than D2 computed around p2, then p2 will be picked. Similar, p1 is picked if D2 is larger than D1. This idea is based on the assumption that large backward synthesis error is closely related to large input depth image noise. If errors D1 and D2 are similar, the Equation (6) can then be used.

Similarly to Embodiment 2, in a different implementation both p1 and p2 could be discarded if none of them is good enough. For example, as illustrated in FIG. 10, p1 (p2) could be discarded if the corresponding backward synthesis error D1 (D2) is above a given threshold.

FIG. 10 shows another merging process utilizing depth, backward synthesis error, and camera parameters, in accordance with an embodiment of the present principles. At step 1002, a synthesized image from reference view 1 is input to the process 1000. At step 1005, reference view 1 is backward synthesized, and the re-synthesized reference view 1 is compared with input reference view 1. At step 1010, the difference (error) with the input reference view, D1, is input to the process 1000.

At step 1004, a synthesized image from reference view 2 is input to the process 1000. At step 1050, reference view 2 is backward synthesized, and the re-synthesized reference view 2 is compared with input reference view 2. At step 1055, the difference (error) with the input reference view, D2, is input to the process 1000. Note that D1 and D2 are used in at least step 1040 and steps following after step 1040.

At step 1003, p1, p2 (same image position with p) is input to the process. At step 1020, it is determined whether or not |depth(p1)−depth(p2)|>depthThreshold. If so, then control is passed to a step 1025. Otherwise, control is passed to step 1040.

At step 1025, the one (either p1 or p2) closer to the camera (i.e., Z-buffering) is picked for p.

At step 1040, it is determined whether or not both D1 and D2 are smaller than a threshold at a small neighborhood around p. If so, then control is passed to a step 1015. Otherwise, control is passed to a step 1060.

At step 1015, D1 and D2 are compared at a small neighborhood around p, and it is determined whether or not they are similar. If so, the control is passed to a function block 1030. Otherwise, control is passed to a function block 1035.

At step 1030, p1 and p2 are averages using Equation (6).

At step 1035, the one (either p1 or p2) with less error is picked for p.

At step 1060, it is determined whether or not D1 is smaller than a threshold at a small neighborhood around p. If so, then control is passed to a function block 1065. Otherwise, control is passed to a step 1070.

At step 1065, p1 is picked for p.

At step 1070, it is determined whether or not D2 is smaller than a threshold at a small neighborhood around p. If so, then control is passed to a step 1075. Otherwise, control is passed to a step 1080.

At step 1075, p2 is picked for p.

At step 1080, p is marked as a hole.

### Embodiment 4: Using High Frequency Energy

In this embodiment, the high frequency energy is proposed as a metric to evaluate the quality of warped pixels. A significant increase in spatial activity after forward warping is likely to indicate the presence of errors during the warping process (for example, due to bad depth information). Since higher spatial activity translates to more energy in high frequencies, we propose using the high frequency energy information computed on image patches (such as, for example, but not limited to, blocks of M×N pixels). In a particular implementation, if there are not many holes around a pixel from all the reference views, then we propose to use any high frequency filter to process the block around a pixel and select the one with lower energy in high frequency. Eventually, no pixel could be selected if all have high energy at high frequency. This embodiment can be an alternative or complement to Embodiment 3.

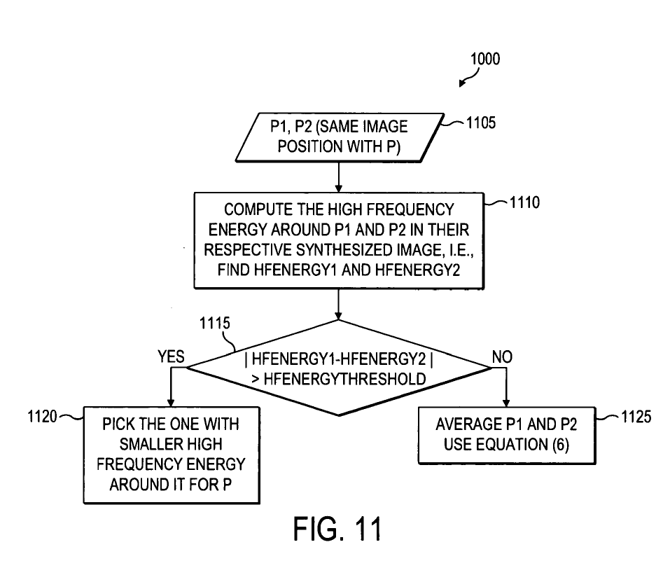

FIG. 11 shows a merging process utilizing high frequency energy, in accordance with an embodiment of the present principles. At step 1105, p1, p2 (same image position with p) are input to process 1100. At step 1110, the high frequency energy around p1 and p2 in their respective synthesized image is computed (i.e., find hfEnergy1 and hfEnergy2). At step 1115, it is determined whether or not |hfEnergy1|hfEnergy2|>hfEnergyThreshold. If so, then control is passed to a step 1120. Otherwise, control is passed to a step 1125.

At step 1120, the one (either p1 or p2) with the smaller high frequency energy around it is picked for p. At step 1125, p1 and p2 are averaged, for example, using Equation (6).

In other implementations, the high frequency energy in a synthesized image is compared to the high frequency energy of the reference image prior to warping. A threshold may be used in the comparison, with the threshold being based on the high frequency energy of the reference image prior to warping.

### Post-Processing: Hole-Filling

Some pixels in the merged synthesized image might still be holes. The simplest approach to address these holes is to examine pixels bordering the holes and use some to fill the holes. However, any existing hole-filling scheme can be applied.

Thus, to summarize, in at least one implementation, we propose: (1) to apply splatting only to pixels around boundary layers; and (2) two merging schemes using hole-distribution or backward synthesis error with Z-buffering. For those solutions and implementations that are heuristic, there could be many potential variations.

Some of these variations, as they relate to the various embodiments described herein, are as follows. However, it is to be appreciated that given the teachings of the present principles provided herein, one of ordinary skill in this and related arts will contemplate these and other variations of the present principles, while maintaining the spirit of the present principles.

During the description of Embodiment 1, we use the example of rectified view synthesis. Nothing prevents the same boundary-layer splatting scheme to be applied to non-rectified views. In this case, each warped pixel is often mapped to its four neighboring target pixels. With Embodiment 1, for each warped pixel in the non-boundary part, we could map it to only one or two nearest neighboring target pixels or give much smaller weighting to the other neighboring target pixels.

In Embodiment 2 and 3, the number of holes around p1 and p2 or the backward synthesis error around p1 and p2 are used to help select one of them as the final value for pixel p in the merge image. This binary weighing scheme (0 or 1) can be extended to non-binary weighting. In the case of Embodiment 2, less weight (instead of 0 as in FIG. 8) can be given if the pixel has more holes around it. Similarly for Embodiment 3, less weight (instead of 0 as in FIG. 9) is given if the pixel's neighborhood has a higher backward synthesis error.

In Embodiments 2 and 3, candidate pixels p1 and p2 can be completely discarded for the computation of p if they are not good enough. Different criteria can be used to decide whether a candidate pixel is good, like the number of holes, the backward synthesis error or a combination of factors. The same applies when more than 2 reference views are used.

In Embodiment 2, 3 and 4, we presume two reference views. Since we are comparing the number of holes, the backward synthesis error among synthesized images or high frequency energy from each reference view, such embodiments may be easily extended to involve the comparison to any number of reference views. In this case, a non-binary weighting scheme might serve better.

In Embodiment 2, the number of holes in a neighborhood of a candidate pixel is used to determine its usage in the blending process. In addition to the number of holes, we may take into account the size of the holes, their density, and so forth. In general, any metric based on the holes in a neighborhood of candidate pixels can be used, while maintaining the spirit of the present principles.

In Embodiments 2 and 3, the hole count and backward synthesis error are used as metrics for assessing the noisiness of the depth maps in the neighborhood of each candidate pixel. The rationale is that the noisier the depth map in its neighborhood, the less reliable the candidate pixel. In general, any metric can be used to derive an estimate of the local noisiness of the depth map, while maintaining the spirit of the present principles.

We have thus described various implementations. One or more of these implementations assess a first candidate pixel from a first warped reference view and a second candidate pixel from a second warped reference view. The assessment is based on at least one of a backward synthesis process to assess a quality of the first and second candidate pixels, a hole distribution around the first and second candidate pixels, or on an amount of energy around the first and second candidate pixels above a specified frequency. The assessing occurs as part of merging at least the first and second warped reference views into a signal synthesized view. Quality may be indicated, for example, based on hole distribution, high frequency energy content, and/or an error between a backward-synthesized view and an input reference view (see, for example, FIG. 10, element 1055). Quality may also (alternatively, or additionally) be indicated by a comparison of such errors for two different reference views and/or a comparison of such errors (or a difference between such errors) to one or more thresholds. Further, various implementations also determine, based on the assessing, a result for a given target pixel in the single synthesized view. Such a result may be, for example, determining a value for the given target pixel, or marking the given target pixel as a hole.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. We thus provide one or more implementations having particular features and aspects. However, features and aspects of described implementations may also be adapted for other implementations. Accordingly, although implementations described herein may be described in a particular context, such descriptions should in no way be taken as limiting the features and concepts to such implementations or contexts.

Reference in the specification to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Implementations may signal information using a variety of techniques including, but not limited to, in-band information, out-of-band information, datastream data, implicit signaling, and explicit signaling. In-band information and explicit signaling may include, for various implementations and/or standards, slice headers, SEI messages, other high level syntax, and non-high-level syntax. Accordingly, although implementations described herein may be described in a particular context, such descriptions should in no way be taken as limiting the features and concepts to such implementations or contexts.

The implementations and features described herein may be used in the context of the MPEG-4 AVC Standard, or the MPEG-4 AVC Standard with the MVC extension, or the MPEG-4 AVC Standard with the SVC extension. However, these implementations and features may be used in the context of another standard and/or recommendation (existing or future), or in a context that does not involve a standard and/or recommendation.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data blended or merged warped-reference-views, or an algorithm for blending or merging warped reference views. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the following claims.

1. A method comprising:
assessing a first candidate pixel from a first warped reference view and a second candidate pixel from a second warped reference view based on at least one of a backward synthesis process to assess a quality of the first and second candidate pixels, a hole distribution around the first and second candidate pixels, or on an amount of energy around the first and second candidate pixels above a specified frequency, the assessing occurring as part of merging at least the first and second warped reference views into a signal synthesized view; and
determining, based on the assessing, a result for a given target pixel in the single synthesized view.

2. The method of claim 1, wherein determining the result comprises determining a value for the given target pixel.

3. The method of claim 1, wherein determining the result comprises determining that the given target pixel is a hole.

4. The method of claim 2, wherein the hole distribution comprises a first hole count indicating a number of holes around the first candidate pixel and a second hole count indicating a number of holes around the second candidate pixel, and wherein determining the value of the given target pixel comprises selecting, as the value for the given target pixel, whichever of the first candidate pixel or the second candidate pixel has a lowest hole count value from among the first hole count and the second hole count.

5. The method of claim 4, wherein selecting, as the value for the given target pixel, whichever of the first candidate pixel or the second candidate pixel has the lowest hole count value, is only performed when a difference between the first hole count and the second hole count is greater than a pre-determined threshold difference.

6. The method of claim 4, wherein selecting, as the value for the given target pixel, whichever of the first candidate pixel or the second candidate pixel has the lowest hole count value, is only performed when the difference between the first hole count and the second hole count is greater than a pre-determined threshold difference and a difference between a depth of the first candidate pixel and the second candidate pixel is not greater than a pre-determined threshold depth.

7. The method of claim 4, wherein determining the value of the given target pixel comprises averaging a value of the first candidate pixel and the second candidate pixel when the difference between the first hole count and the second hole count is not greater than the pre-determined threshold difference.

8. The method of claim 7, wherein averaging the value of the first candidate pixel and the second candidate pixel, is only performed when the difference between the first hole count and the second hole count is not greater than a pre-determined threshold difference and a difference between a depth of the first candidate pixel and the second candidate pixel is not greater than a pre-determined threshold depth.

9. The method of claim 7, wherein averaging the value of the first candidate pixel and the second candidate pixel comprises using weight factors for each of the first candidate pixel and the second candidate pixel.

10. The method of claim 9, wherein the weight factors are determined based on at least one of a distance between the first warped reference view and the single synthesized view and a distance between the second warped reference view and the single synthesized view.

11. The method of claim 9, wherein the weight factors are determined based upon the first hole count and the second hole count.

12. The method of claim 9, wherein the weight factors are determined based locations of the holes around the first candidate pixel and the second candidate pixel.

13. The method of claim 11, wherein the hole distribution further is based on the locations of the holes around the first candidate pixel and the second candidate pixel, and
wherein determining the value of the given target pixel comprises selecting as the value for the given target pixel, or assigning a higher weight factor to, whichever of the first candidate pixel or the second candidate pixel has the holes most predominately located on a given side thereof.

14. The method of claim 2, wherein the hole distribution further comprises locations of holes around the first candidate pixel and the second candidate pixel, and
wherein determining the value of the given target pixel comprises selecting as the value for the given target pixel, or assigning a higher weight factor to, whichever of the first candidate pixel or the second candidate pixel has the holes most predominately located on a given side thereof.

15. The method of claim 4, wherein both of the first candidate pixel and the second candidate pixel are discarded from use in determining the value for the given target pixel, when the first hole count and the second hole count are both above a pre-determined threshold hole count value.

16. The method of claim 2, wherein the backward synthesis process comprises:
re-synthesizing the first reference view and the second reference view to respectively provide a re-synthesized first warped reference view and a re-synthesized second warped reference view;
computing a first difference between the re-synthesized first reference view and a first reference view from which the first warped reference view was obtained;
computing a second difference between the re-synthesized second reference view and a second reference view from which the second warped reference view was obtained,
calculating a first sum with respect to the first difference being applied to a neighborhood around the first candidate pixel;
calculating a second sum with respect to the second difference being applied to a neighborhood around the second candidate pixel; and
the method further comprises determining a value for the given target pixel based on at least one of the first sum and the second sum.

17. The method of claim 16, wherein determining the value of the given target pixel based on at least one of the first sum and the second sum comprises:
selecting, as the value for the given target pixel:
the first candidate pixel when the first sum is less than the second sum and a difference between the first sum and the second sum is greater than a pre-specified threshold difference;
the second candidate pixel when the second sum is less than the first sum and the difference between the first sum and the second sum is greater than a pre-specified threshold difference; and
averaging a value of the first candidate pixel and the second candidate pixel, when the difference between the first sum and the second sum is not greater than a pre-specified threshold difference.

18. The method of claim 17, wherein averaging the value of the first candidate pixel and the second candidate pixel comprises using weight factors for each of the first candidate pixel and the second candidate pixel.

19. The method of claim 16, further comprising discarding at least one of the first candidate pixel and the second candidate pixel when at least one of the first sum and the second sum is greater than a pre-specified threshold sum.

20. The method of claim 19, further comprising marking the given target pixel as a hole, when the first sum and the second sum are greater than the pre-specified threshold sum.

21. The method of claim 2, wherein the hole distribution comprises a first hole count indicating a number of holes around the first candidate pixel and a second hole count indicating a number of holes around the second candidate pixel, and wherein selecting, for the given target pixel in the single synthesized view, the first candidate pixel and the second candidate pixel comprises selecting whichever of the first candidate pixel or the second candidate pixel has a lower value for the amount of energy when the first hole count and the second hole count are below a given threshold hole count.

22. The method of claim 2, further comprising discarding any of the first candidate pixel and the second candidate pixel having the amount of energy above a given threshold.

23. The method of claim 2, wherein determining the value of the given target pixel in the single synthesized view comprises:
determining the amount of energy around the first candidate pixel to obtain a first amount;
determining the amount of energy around the second candidate pixel to obtain a second amount;
selecting one of, or discarding one of, or combining, the first candidate pixel and the second candidate pixel based on at least one of the first amount and the second amount.

24. The method of claim 23, wherein the hole distribution comprises a first hole count indicating a number of holes around the first candidate pixel and a second hole count indicating a number of holes around the second candidate pixel, and wherein selecting one of, or discarding one of, or combining, the first candidate pixel and the second candidate pixel, is further based on at least one of the first hole count and the second hole count.

25. The method of claim 24, wherein the hole distribution further is based on locations of holes around the first candidate pixel and the second candidate pixel, and wherein selecting one of, or discarding one of, or combining, the first candidate pixel and the second candidate pixel, is further based on at least one of the locations of holes around the first candidate pixel and the locations of holes around the second candidate pixel.

26. An apparatus comprising:
means for assessing a first candidate pixel from a first warped reference view and a second candidate pixel from a second warped reference view based on at least one of a backward synthesis process to assess a quality of the first and second candidate pixels, a hole distribution around the first and second candidate pixels, or on an amount of energy around the first and second candidate pixels above a specified frequency, the assessing occurring as part of merging at least the first and second warped reference views into a signal synthesized view; and
means for determining, based on the assessing, a result for a given target pixel in the single synthesized view.

27. A processor readable medium having stored therein instructions for causing a processor to perform at least the following:
assessing a first candidate pixel from a first warped reference view and a second candidate pixel from a second warped reference view based on at least one of a backward synthesis process to assess a quality of the first and second candidate pixels, a hole distribution around the first and second candidate pixels, or on an amount of energy around the first and second candidate pixels above a specified frequency, the assessing occurring as part of merging at least the first and second warped reference views into a signal synthesized view; and
determining, based on the assessing, a result for a given target pixel in the single synthesized view.

28. An apparatus, comprising a processor configured to perform at least the following:
assessing a first candidate pixel from a first warped reference view and a second candidate pixel from a second warped reference view based on at least one of a backward synthesis process to assess a quality of the first and second candidate pixels, a hole distribution around the first and second candidate pixels, or on an amount of energy around the first and second candidate pixels above a specified frequency, the assessing occurring as part of merging at least the first and second warped reference views into a signal synthesized view; and
determining, based on the assessing, a result for a given target pixel in the single synthesized view.

29. An apparatus comprising a view merger, the view merger configured for:
assessing a first candidate pixel from a first warped reference view and a second candidate pixel from a second warped reference view based on at least one of a backward synthesis process to assess a quality of the first and second candidate pixels, a hole distribution around the first and second candidate pixels, or on an amount of energy around the first and second candidate pixels above a specified frequency, the assessing occurring as part of merging at least the first and second warped reference views into a signal synthesized view; and
determining, based on the assessing, a result for a given target pixel in the single synthesized view.

30. The apparatus of claim 29, wherein the apparatus includes an encoder.

31. The apparatus of claim 29, wherein the apparatus includes a decoder.

32. The apparatus of claim 29, wherein the view merger comprises:
a hole marker for marking the given target pixel as a hole.

33. An apparatus comprising:
a view merger, the view merger configured for:
assessing a first candidate pixel from a first warped reference view and a second candidate pixel from a second warped reference view based on at least one of a backward synthesis process to assess a quality of the first and second candidate pixels, a hole distribution around the first and second candidate pixels, or on an amount of energy around the first and second candidate pixels above a specified frequency, the assessing occurring as part of merging at least the first and second warped reference views into a signal synthesized view, and
determining, based on the assessing, a result for a given target pixel in the single synthesized view; and
a modulator for modulating a signal, the signal including the single synthesized view.

34. The apparatus of claim 33, wherein the apparatus includes an encoder.

35. The apparatus of claim 33, wherein the apparatus includes a decoder.

36. An apparatus comprising:
a demodulator for demodulating a signal, the signal including at least a first warped reference view and a second warped reference view; and
a view merger, the view merger configured for:
assessing a first candidate pixel from a first warped reference view and a second candidate pixel from a second warped reference view based on at least one of a backward synthesis process to assess a quality of the first and second candidate pixels, a hole distribution around the first and second candidate pixels, or on an amount of energy around the first and second candidate pixels above a specified frequency, the assessing occurring as part of merging at least the first and second warped reference views into a signal synthesized view, and
determining, based on the assessing, a result for a given target pixel in the single synthesized view.

37. The method of claim 1, wherein the backward synthesis process is based on depth and is applied to the first and second candidate pixels to produce pixel values for backward synthesized first and second reference views to assess the quality of the first and second candidate pixels.
